(19) United States
(12) Patent Application Publication
(10) Pub. No.: US 2025/0011665 A1
(43) Pub. Date: Jan. 9, 2025

(54) PROCESS FOR HYDROPROCESSING A BIORENEWABLE FEEDSTOCK

(71) Applicant: UOP LLC, Des Plaines, IL (US)

(72) Inventors: Vikrant Vilasrao Dalal, Gurugram (IN); Gaurav Srivastava, Fatehgarh (IN); Arunim Bose, Gurugram (IN); Stanley Joseph Frey, Palatine, IL (US); Eseoghene Jeroro, Chicago, IL (US)

(21) Appl. No.: 18/754,710

(22) Filed: Jun. 26, 2024

Related U.S. Application Data
(60) Provisional application No. 63/512,085, filed on Jul. 6, 2023.

(51) Int. Cl. C10G 65/12

(52) U.S. Cl. CPC C10G 65/12; C10G 2300/4018; C10G 2300/4081; C10G 2400/04; C10G 2400/08

(57) ABSTRACT

A process for hydroprocessing a biorenewable feedstock is disclosed. The process comprises hydrotreating the biorenewable feed stream in a hydrotreating reactor to hydrodeoxygenate the biorenewable feed stream to provide a hydrotreated stream. A hydrocracking feed stream taken from the hydrotreated stream is hydrocracked in a hydrocracking reactor to provide a hydrocracked stream. A hydroisomerization feed stream taken from the hydrotreated stream is hydroisomerized in a hydroisomerization reactor to provide a hydroisomerized stream. The hydroisomerized stream is separated to provide a jet fuel stream and a diesel stream. The diesel stream is separated into a first recycle diesel stream and a second recycle diesel stream. The first recycle diesel stream is passed to the hydrocracking reactor and the second recycle diesel stream is passed to the hydroisomerization reactor.

### FIELD

The field is related to a process for hydroprocessing a biorenewable feedstock. The field may particularly relate to a process for hydroprocessing a biorenewable feedstock with a recycled diesel stream.

### BACKGROUND

As the demand for fuel increases worldwide, there is increasing interest in producing fuels and blending components from sources other than crude oil. Often referred to as a biorenewable source, these sources include, but are not limited to, plant oils such as corn, rapeseed, canola, soybean, microbial oils such as algal oils, animal fats such as inedible tallow, fish oils and various waste streams such as yellow and brown greases and sewage sludge. A common feature of these sources is that they are composed of glycerides and free fatty acids (FFA). Both triglycerides and the FFAs contain aliphatic carbon chains having from about 8 to about 24 carbon atoms. The aliphatic carbon chains in triglycerides or FFAs can be fully saturated, or mono, di or poly-unsaturated.

Hydroprocessing can include processes which convert hydrocarbons in the presence of hydroprocessing catalyst and hydrogen to more valuable products. Hydrotreating is a process in which hydrogen is contacted with hydrocarbons in the presence of hydrotreating catalysts which are primarily active for the removal of heteroatoms, such as sulfur, nitrogen, oxygen and metals from the hydrocarbon feedstock. In hydrotreating, hydrocarbons with double and triple bonds such as olefins may be saturated.

The production of hydrocarbon products in the diesel boiling range can be achieved by hydrotreating a biorenewable feedstock. A biorenewable feedstock can be hydroprocessed by hydrotreating to deoxygenate, including decarboxylate and decarbonylate, the oxygenated hydrocarbons. Hydrotreating may be followed by hydroisomerization to improve cold flow properties of product diesel and jet fuel. Hydroisomerization or hydrodewaxing is a hydroprocessing process that increases the alkyl branching on a hydrocarbon backbone in the presence of hydrogen and hydroisomerization catalyst to improve cold flow properties of the hydrocarbon. Hydroisomerization includes hydrodewaxing herein.

Hydrocracking is a hydroprocessing process in which hydrocarbons crack in the presence of hydrogen and hydrocracking catalyst to lower molecular weight hydrocarbons. Depending on the desired output, a hydrocracking unit may contain one or more beds of the same or different catalyst.

As refiners seek to add capability for processing biorenewable feedstocks, processes are sought to produce greater volumes of jet fuel due to its high value and demand. Processes for producing diesel and increased yield of jet fuel from biorenewable feedstocks are desired.

### SUMMARY OF THE INVENTION

The process produces a diesel stream from a biorenewable feedstock by hydrotreating it to remove heteroatoms and hydroisomerizing it to improve cold flow properties. The diesel stream can be hydrocracked to provide jet fuel range material. The process produces jet fuel range material which meets the jet fuel specification without affecting or compromising the jet fuel yield.

### BRIEF DESCRIPTION OF THE DRAWINGS

FIG. 1 is a simplified process flow diagram of the process for hydroprocessing a biorenewable feedstock in accordance with the present disclosure.

FIG. 2 is a graph plotted between the fuel yield and the % of recycle diesel stream in accordance with an exemplary embodiment of the present disclosure.

FIG. 3 is a graph plotted between the fuel freeze point and the % of recycle diesel stream in accordance with another exemplary embodiment of the present disclosure.

FIG. 4 is a graph plotted between the fuel density and the % of recycle diesel stream in accordance with another exemplary embodiment of the present disclosure.

### DEFINITIONS

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without passing through a fractionation or conversion unit to undergo a compositional change due to physical fractionation or chemical conversion.

The term “indirect communication” means that flow from the upstream component enters the downstream component after passing through a fractionation or conversion unit to undergo a compositional change due to physical fractionation or chemical conversion.

The term “bypass” means that the object is out of downstream communication with a bypassing subject at least to the extent of bypassing.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take a main product from the bottom.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “boiling point temperature” means atmospheric equivalent boiling point (AEBP) as calculated from the observed boiling temperature and the distillation pressure, as calculated using the equations furnished in ASTM D86 or ASTM D2887.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T5” or “T95” means the temperature at which 5 mass percent or 95 mass percent, as the case may be, respectively, of the sample boils using ASTM D-86 or TBP.

As used herein, the term “initial boiling point” (IBP) means the temperature at which the sample begins to boil using ASTM D2887, ASTM D-86 or TBP, as the case may be.

As used herein, the term “end point” (EP) means the temperature at which the sample has all boiled off using ASTM D2887, ASTM D-86 or TBP, as the case may be.

As used herein, the term “jet fuel range material” means hydrocarbons boiling in the range of an IBP between about 85° C. (185° F.) and about 135° C. (275° F.) or a T5 between about 110° C. (230° F.) and about 160° C. (320° F.) and the “recycle cut point” comprising a T95 between about 295° C. (563° F.) and about 315° C. (599° F.) using the TBP distillation method. Hydrocarbons beyond the “recycle cut point” and up to the “diesel cut point” comprising a T95 between about 343° C. (650° F.) and about 399° C. (750° F.) are the “diesel boiling range” material using the TBP distillation method.

As used herein, the term “conversion” means the ratio of product that boils below a recycle cut point to the feed that boils at or above the recycle cut point.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” means greater than 50%, suitably greater than 75% and preferably greater than 90%.

As used herein, the term “Cₓ” is to be understood to refer to molecules having the number of carbon atoms represented by the subscript “x”. Similarly, the term “Cₓ−” refers to molecules that contain less than or equal to x and preferably x and less carbon atoms. The term “Cₓ+” refers to molecules with more than or equal to x and preferably x and more carbon atoms.

As used herein, the term “carbon number” refers to the number of carbon atoms per hydrocarbon molecule and typically a paraffin molecule.

### DETAILED DESCRIPTION

With growing emphasis on environmental and sustainable economy, it has become more and more attractive for refiners to produce green fuels as part of their portfolio to maximize their profitability from Renewable Identification Numbers (RINs) credited under the Renewable Fuel Standard Program. RINs are credits used for compliance which can be traded within the program to increase profitability. The present disclosure enables refiners to produce jet fuel which meets the jet fuel specification without compromising the jet fuel yield of the process.

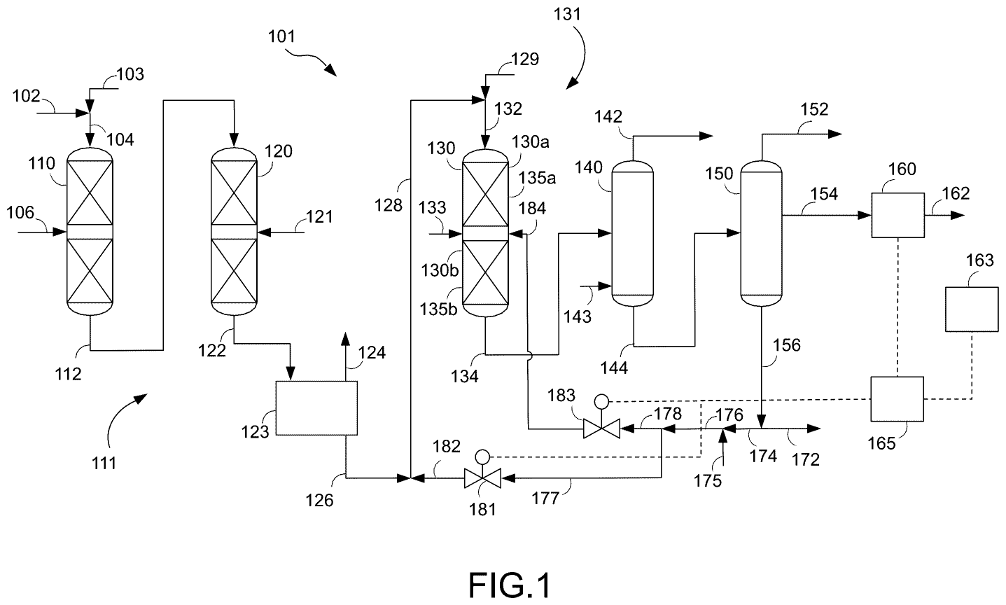

In FIG. 1, in accordance with an exemplary embodiment, a process 101 is shown for hydroprocessing a biorenewable feedstock. The process for hydroprocessing a biorenewable feedstock comprises a hydrotreating section 111 and a hydroprocessing section 131. A feed line 102 transports a feed stream of fresh biorenewable feedstock to the hydrotreating section 111. The biorenewable feedstock may be blended with a mineral feed stream but preferably comprises a predominance of or all biorenewable feedstock. A mineral feedstock is a conventional feed derived from crude oil that is extracted from the ground. The biorenewable feedstock may comprise a nitrogen concentration of about 50 wppm to about 800 wppm. The biorenewable feedstock may comprise high oxygen content which can be up to 10 wt % or higher. The biorenewable feedstock may also comprise about 1 to about 500 wppm sulfur, typically no more than about 200 wppm sulfur.

A variety of different biorenewable feedstocks may be suitable for the process 101. The term “biorenewable feedstock” is meant to include feedstocks other than those obtained from crude oil. The biorenewable feedstock may include any of those feedstocks which comprise at least one glyceride and free fatty acids. Most glycerides will be triglycerides, but monoglycerides and diglycerides may be present and processed as well. Free fatty acids may be obtained from phospholipids which may source phosphorous in the feedstock. Examples of these biorenewable feedstocks include, but are not limited to, camelina oil, canola oil, corn oil, soy oil, rapeseed oil, soybean oil, colza oil, tall oil, sunflower oil, hempseed oil, olive oil, linseed oil, coconut oil, castor oil, peanut oil, palm oil, mustard oil, tallow, yellow and brown greases, lard, train oil, fats in milk, fish oil, algal oil, sewage sludge, and the like. Additional examples of biorenewable feedstocks include non-edible vegetable oils from the group comprising Jatropha curcas (Ratanjot, Wild Castor, Jangli Erandi), Madhuca indica (Mohuwa), Pongamia pinnata (Karanji, Hongc), calophyllum inophyllum, moringa oleifera and Azadirachta indica (Neem). The triglycerides and FFAs of the typical vegetable or animal fat contain aliphatic hydrocarbon chains in their structure which have about 8 to about 30 carbon atoms. As will be appreciated, the biorenewable feedstock may comprise a mixture of one or more of the foregoing examples. The biorenewable feedstock may be pretreated to remove contaminants and filtered to remove solids.

The biorenewable feed stream in feed line 102 may flow from a feed surge drum to the hydrotreating section 111. In accordance with the present disclosure, the hydrotreating section 111 may include a guard bed reactor 110 and a hydrotreating reactor 120. The biorenewable feed stream in feed line 102 may be combined with a hydrogen gas stream in line 103 to provide a combined biorenewable feed stream in line 104. The combined biorenewable feed stream in line 104 is passed to the guard bed reactor 110. Alternately, the biorenewable feed stream in feed line 102 and the hydrogen gas stream in line 103 may be passed separately to the guard bed reactor 110. In an aspect, the biorenewable feed stream in feed line 102 may include a heated biorenewable feed stream.

The guard bed temperature of the guard bed reactor 110 may range between about 246° C. (475° F.) and about 343° C. (650° F.) or between about 288° C. (550° F.) and about 304° C. (580° F.). The guard bed reactor 110 is operated low enough to prevent olefins in the FFA from polymerizing but high enough to foster olefin saturation, hydrodemetallation, hydrodeoxygenation, including hydrodecarbonylation and hydrodecarboxylation, hydrodesulfurization and hydrodenitrification reactions to occur.

The guard bed can comprise a base metal on a support. Base metals useable in this process include non-noble metals, nickel, chromium, molybdenum and tungsten. Other base metals that can be used include tin, indium, germanium, lead, cobalt, gallium and zinc. The process can also use a metal sulfide, wherein the metal in the metal sulfide is selected from one or more of the base metals listed. The biorenewable feedstock can be charged through the base metal catalysts at pressures from 1379 kPa (abs) (200 psia) to 6895 kPa (abs) (1000 psia). In a further embodiment, the guard bed catalyst can comprise a second metal, wherein the second metal includes one or more of the metals: tin, indium, ruthenium, rhodium, rhenium, osmium, iridium, germanium, lead, cobalt, gallium, zinc and thallium. A nickel molybdenum on alumina catalyst may be a suitable catalyst in the guard bed reactor 110. Multiple guard beds may be contained in the guard bed reactor 110 such as 2, 3 or more. A hydrogen quench stream from a hydrogen quench line 106 may be injected at interbed locations to control temperature exotherms.

A contacted biorenewable feed stream is discharged from the guard bed reactor 110 in a contacted feed line 112. In the guard bed reactor 110, most of the hydrodemetallation and hydrodeoxygenation, including hydrodecarbonylation and hydrodecarboxylation, reactions will occur with some hydrodenitrogenation and hydrodesulfurization occurring. Metals removed will include alkali metals and alkali earth metals and phosphorous. The contacted biorenewable feed stream in line 112 may be passed to the hydrotreating reactor 120.

In an aspect, the contacted biorenewable feed stream may be heated to increase the temperature of the contacted biorenewable feed stream before passing the contacted biorenewable feed stream in line 112 to the hydrotreating reactor 120. The heated, contacted biorenewable feed stream is charged to a hydrotreating reactor 120 of the hydrotreating reactor section 111.

In the hydrotreating reactor 120, the heated, contacted biorenewable feed stream in line 112 is contacted with a hydrotreating catalyst in the presence of hydrogen at hydrotreating conditions to saturate the olefinic or unsaturated portions of the n-paraffinic chains in the biorenewable feedstock. The hydrotreating catalyst also catalyzes hydrodeoxygenation reactions, including hydrodecarboxylation and hydrodecarbonylation reactions, to remove oxygenate functional groups from the hydrocarbon molecules in the biorenewable feedstock which are converted to water and carbon oxides. The hydrotreating catalyst also catalyzes hydrodesulfurization of organic sulfur and hydrodenitrogenation of organic nitrogen in the biorenewable feedstock. Essentially, the hydrotreating reaction removes heteroatoms from the hydrocarbons and saturates olefins in the feed stream.

The hydrotreating catalyst may be provided in one, two or more beds. A hydrotreating hydrogen quench stream from a hydrotreating hydrogen quench line 121 may be passed at an interbed location of the hydrotreating reactor 120. In an exemplary embodiment, two hydrotreating catalyst beds are shown in the FIG. 1. However, the hydrotreating reactor 120 may include more than two catalyst beds or a single hydrotreating catalyst bed.

The hydrotreating catalyst may comprise nickel, nickel and molybdenum, or cobalt and molybdenum dispersed on a high surface area support such as alumina. Other catalysts include one or more noble metals dispersed on a high surface area support. Non-limiting examples of noble metals include platinum and/or palladium dispersed on an alumina support such as gamma-alumina. Suitable hydrotreating catalysts include BDO 200, BDO 300 or BDO 400 available from UOP LLC in Des Plaines, Illinois. The hydrotreating reaction temperature may range from between about 343° C. (650° F.) and about 427° C. (800° F.) and preferably between about 349° C. (690° F.) and about 400° C. (752° F.). Generally, hydrotreating conditions include a pressure of about 700 kPa (100 psig) to about 21 MPa (3000 psig).

A hydrotreated stream is produced in a hydrotreated line 122 from the hydrotreating reactor 120 of the hydrotreating reactor section 111 comprising a hydrocarbon fraction which has a substantial n-paraffin concentration. Oxygenate concentration in the hydrocarbon fraction is essentially nil, whereas the olefin concentration is substantially reduced relative to the contacted biorenewable feed stream. The organic sulfur concentration in the hydrocarbon fraction is no more than 500 wppm and the organic nitrogen concentration in the hydrocarbon fraction is less than 10 wppm.

The hydrotreated stream in the hydrotreated line 122 may be separated to provide a hydrotreated vapor stream and a hydrotreated liquid stream having a smaller oxygen concentration than the biorenewable feed stream. In an aspect, the hydrotreated stream in the hydrotreated line 122 may be passed to a separation section 123 to provide a hydrotreated vapor stream in line 124 and a hydrotreated liquid stream in line 126 having a smaller oxygen concentration than the biorenewable feed stream 102. In an exemplary embodiment, the separation section 123 may include a separator, one or more additional separators and/or a stripper column. In accordance with the present disclosure, the hydrotreated vapor stream in line 124 may be withdrawn and processed to provide one or more of the hydrogen gas stream in line 103, the hydrogen quench stream in line 106, and the hydrotreating hydrogen quench stream in line 121. A liquid stream from the separation section 123 may be recycled to the hydrotreating reactor 120 and/or the hydrotreating section 111.

A desired product, such as a transportation fuel, may be recovered or separated from the hydrotreated liquid stream in line 126. However, the hydrotreated liquid stream in line 126 comprises a higher concentration of normal paraffins, and it will possess poor cold flow properties. Accordingly, to improve the cold flow properties, the hydrotreated liquid stream in line 126 may be passed to the hydroprocessing section 131. In accordance with the present disclosure, the hydroprocessing section 131 comprises a hydrocracking reactor and a hydroisomerization reactor. In the hydroprocessing section 131, the hydrotreated liquid stream in line 126 may be contacted with a hydroisomerization catalyst in the hydroisomerization reactor under hydroisomerization conditions to hydroisomerize the normal paraffins to branched paraffins.

In an aspect, a hydrocracking reactor 130a and a hydroisomerization reactor 130b are located in a single vessel. In an exemplary embodiment, the hydroprocessing section 131 comprises a hydroprocessing reactor 130 comprising the hydrocracking reactor 130a and the hydroisomerization reactor 130b.

Generally, the process for producing the jet fuel range material includes a single reactor for hydroisomerizing the deoxygenated product coming from the hydrotreating reactor. Also, an unconverted recycle stream which may comprise a recycle diesel stream may be passed to the hydroprocessing reactor 130 along with the hydrotreated liquid stream for hydroisomerization.

In the embodiment in FIG. 1 with a hydrocracking reactor 130a stacked with a hydroisomerization reactor 130b, the temperature of the hydroisomerization reactor 130b is dictated by the hydroisomerization catalyst activity required to achieve the jet fuel specification which may be a target freeze point specification for jet fuel. However, the high temperature operation of the hydrocracking catalyst results in a loss of jet fuel range material to Co. material due to hydrocracking. Therefore, the yield of the jet fuel range material meeting the desired specification may be reduced. The present disclosure provides a process for managing the feed going to the hydrocracking catalyst and the jet fuel range material produced from the process. The process includes a dual feed injection with variable liquid hourly space velocity (LHSV) to selectively adjust the flow rate of recycle diesel stream going to the hydrocracking catalyst reactor 130a or a hydrocracking catalyst bed 135a located in the hydrocracking catalyst reactor 130a to produce the jet fuel range material meeting a given specification of density, freeze point, or viscosity without compromising the jet fuel yield. The disclosed process with a stacked configuration for the hydrocracking reactor 130a or the hydrocracking catalyst bed 135a and the hydroisomerization reactor 130b or a hydroisomerization catalyst bed 135b produces jet fuel which meets the jet fuel specifications as dictated by ASTM D7566. Instead of sending the whole recycle diesel stream to the hydrocracking catalyst, the process controls the proportion of recycle diesel stream which is passed to the hydrocracking catalyst. In an aspect, the LHSV of the hydrocracking reactor 130a is higher or equal to the LHSV of the hydroisomerization reactor 130b.

The present process measures one or more of the density and viscosity of the jet fuel produced from the process and compares the measured value of one or more of the density and viscosity with a corresponding set point value. Based on the comparison, the recycle diesel stream is split in two parts, with one part is proposed to mix with hydrotreated liquid stream in line 126 and passed to the hydrocracking reactor 130a or the hydrocracking catalyst bed 135a located in the hydrocracking catalyst reactor 130a. The other or the remaining portion of the recycle diesel stream is passed to the inlet of the downstream hydroisomerization reactor 130b or the hydroisomerization catalyst bed 135b located in the hydroisomerization reactor 130b. The process will help retain higher jet fuel yield and minimize the cracking of jet fuel range material to Co-material.

Referring to the hydroprocessing section 131, the hydrotreated liquid stream in line 126 is passed to the hydrocracking reactor 130a. In accordance with the present disclosure, a first diesel recycle stream in line 182 is also passed to the hydrocracking reactor 130a. In an exemplary embodiment, the first diesel recycle stream in line 182 and the hydrotreated liquid stream in line 126 are combined or mixed to provide a hydroprocessing feed stream in line 128. The hydroprocessing feed stream in line 128 is passed to the hydrocracking reactor 130a. A hydrocracking hydrogen stream in line 129 is also passed to the hydrocracking reactor 130a. In an embodiment, the hydroprocessing feed stream in line 128 is combined with the hydrocracking hydrogen stream in line 129 to provide a combined hydroprocessing feed stream in line 132. The combined hydroprocessing feed stream in line 132 is passed to the hydrocracking reactor 130a.

The hydrocracking reactor 130a may be a fixed bed reactor that may comprise single or multiple catalyst beds and various combinations of hydrocracking catalyst in one or more vessels. The hydrocracking reactor 130a may be operated in a conventional continuous gas phase, a moving bed or a fluidized bed hydroprocessing reactor. The hydrotreated liquid stream and the first recycle diesel stream are hydroprocessed over a hydrocracking catalyst in the hydrocracking reactor 130a in the presence of the hydrocracking hydrogen stream to provide a hydrocracked stream.

The hydrocracking reactor 130a may provide a total conversion of at least about 20 vol % and typically greater than about 60 vol % of the first recycle diesel stream to products boiling below the diesel range of about 293° C. (560° F.) to about 310° C. (590° F.). The hydrocracking reactor 130a may operate at partial conversion of more than about 30 vol % or full conversion of at least about 90 vol % of the feed based on total conversion. The hydrocracking reactor 130a may be operated at mild hydrocracking conditions which will provide about 20 to about 60 vol %, preferably about 20 to about 50 vol %, total conversion of the hydrocracking feed stream to product boiling below the diesel boiling range.

The hydrocracking catalyst may utilize amorphous silica-alumina bases or zeolite bases combined with one or more Group VIII or Group VIB metal hydrogenating components to selectively produce a balance of light diesel and jet fuel distillate. In another aspect, a catalyst which comprises, in general, any crystalline zeolite cracking base upon which is deposited a Group VIII metal hydrogenating component may be suitable. Additional hydrogenating components may be selected from Group VIB for incorporation with the zeolite base.

The zeolite cracking bases are sometimes referred to in the art as molecular sieves and are usually composed of silica, alumina and one or more exchangeable cations such as sodium, magnesium, calcium, rare earth metals, etc. They are further characterized by crystal pores of relatively uniform diameter between about 4 and about 14 Angstroms. It is preferred to employ zeolites having a relatively high silica/alumina mole ratio between about 3 and about 12. Suitable zeolites found in nature include, for example, mordenite, stilbite, heulandite, ferrierite, dachiardite, chabazite, crionite and faujasite. Suitable synthetic zeolites include, for example, the B, X, Y and L crystal types, e.g., synthetic faujasite and mordenite. The preferred zeolites are those having crystal pore diameters between about 8 and 12 Angstroms, wherein the silica/alumina mole ratio is about 4 to 6. One example of a zeolite falling in the preferred group is synthetic Y molecular sieve.

The natural occurring zeolites are normally found in a sodium form, an alkaline earth metal form, or mixed forms. The synthetic zeolites are nearly always prepared in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,100,006.

Mixed polyvalent metal-hydrogen zeolites may be prepared by ion-exchanging with an ammonium salt, then partially back exchanging with a polyvalent metal salt and then calcining. In some cases, as in the case of synthetic mordenite, the hydrogen forms can be prepared by direct acid treatment of the alkali metal zeolites. In one aspect, the preferred cracking bases are those which are at least about 10 wt %, and preferably at least about 20 wt %, metal-cation-deficient, based on the initial ion-exchange capacity. In another aspect, a desirable and stable class of zeolites is one wherein at least about 20 wt % of the ion exchange capacity is satisfied by hydrogen ions.

The active metals employed in the preferred hydrocracking catalysts of the present disclosure as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 wt % and about 30 wt % may be used. In the case of noble metals, it is normally preferred to use about 0.05 to about 2 wt % noble metal. Noble metals may be preferred as the hydrogenation metal on the hydrocracking catalyst to provide selectivity to jet fuel due to the absence of hydrogen sulfide and ammonia which can deactivate noble metal catalysts, but which have been removed upstream in the process.

The method for incorporating the hydrogenation metal is to contact the base material with an aqueous solution of a suitable compound of the desired metal wherein the metal is present in a cationic form. Following addition of the selected hydrogenation metal or metals, the resulting catalyst powder is then filtered, dried, pelleted with added lubricants, binders or the like if desired, and calcined in air at temperatures of, e.g., about 371° C. (700° F.) to about 648° C. (1200° F.) in order to activate the catalyst and decompose ammonium ions. Alternatively, the base component may be pelleted, followed by the addition of the hydrogenation component and activation by calcining.

The foregoing catalysts may be employed in undiluted form, or the powdered catalyst may be mixed and copelleted with other relatively less active catalysts, diluents or binders such as alumina, silica gel, silica-alumina cogels, activated clays and the like in proportions ranging between about 5 and about 90 wt %. These diluents may be employed as such, or they may contain a minor proportion of an added hydrogenating metal such as a Group VIB and/or Group VIII metal. Additional metal promoted hydrocracking catalysts may also be utilized in the process of the present disclosure which comprises, for example, aluminophosphate molecular sieves, crystalline chromosilicates and other crystalline silicates. Crystalline chromosilicates are more fully described in U.S. Pat. No. 4,363,178.

DI-100 available from UOP LLC in Des Plaines, Illinois may be a suitable hydrocracking catalyst.

By one approach, the hydrocracking conditions may include a temperature from about 290° C. (550° F.) to about 468° C. (875° F.), preferably 300° C. (572° F.) to about 445° C. (833° F.), a pressure from about 2.7 MPa (gauge) (400 psig) to about 20.7 MPa (gauge) (3000 psig), a LHSV from about 0.4 to less than about 20 hr⁻¹ and a hydrogen rate of about 253 Nm³/m³ (1,500 scf/bbl) to about 2,527 Nm³/m³ oil (15,000 scf/bbl).

A hydrocracked stream may exit the hydrocracking reactor 130a. In an embodiment, the hydrocracked stream may feed directly to the hydroisomerization reactor 130b. In accordance with the present disclosure, a second recycle diesel stream in line 184 is passed to the hydroisomerization reactor 130b along with the hydrocracked stream from the hydrocracking reactor 130a. A hydroisomerization hydrogen stream in line 133 is also passed to the hydroisomerization reactor 130b. The hydrocracked stream and the second recycle diesel stream in line 184 may be hydroisomerized over hydroisomerization catalyst in the presence of the hydroisomerization hydrogen stream.

Hydroisomerization, including hydrodewaxing, of the normal hydrocarbons in the hydroisomerization reactor 130b can be accomplished over one or more beds of hydroisomerization catalyst, and the hydroisomerization may be operated in a co-current mode of operation. Fixed bed, trickle bed down-flow or fixed bed liquid filled up-flow modes are both suitable. A make-up hydrogen quench stream may be provided for interbed quenching to the hydroisomerization reactor 130b.

Suitable hydroisomerization catalysts may comprise a metal of Group VIII (IUPAC 8-10) of the Periodic Table and a support material. Suitable Group VIII metals include platinum and palladium, each of which may be used alone or in combination. The hydroisomerization catalyst may include non-noble metals which are not as susceptible to sulfur deactivation in a sour environment. Examples of suitable non-noble metals include Ni, Mo, Co, W, Mn, Cu, Zn or Ru. Mixtures of hydrogenation metals may also be used such as Co/Mo, Ni/Mo and Ni/W. The amount of hydrogenation metal or metals may range from 0.1 to 5 wt. %, based on the catalyst weight. Methods of loading metal onto the support material include, for example, impregnation of the support material with a metal salt of the hydrogenation component and heating. The catalyst support material containing the hydrogenation metal may also be sulfided prior to use.

The support material may be amorphous or crystalline. Suitable support materials include amorphous alumina, amorphous silica-alumina, ferrierite, ALPO-31, SAPO-11, SAPO-31, SAPO-37, SAPO-41, SM-3, MgAPSO-31, FU-9, NU-10, NU-23, ZSM-12, ZSM-22, ZSM-23, ZSM-35, ZSM-48, ZSM-50, ZSM-57, MeAPO-11, MeAPO-31, MeAPO-41, MgAPSO-11, MgAPSO-31, MgAPSO-41, MgAPSO-46, ELAPO-11, ELAPO-31, ELAPO-41, ELAPSO-11, ELAPSO-31, ELAPSO-41, laumontite, cancrinite, offretite, hydrogen form of stillbite, magnesium or calcium form of mordenite, and magnesium or calcium form of partheite, each of which may be used alone or in combination. ALPO-31 is described in U.S. Pat. No. 4,310,440. SAPO-11, SAPO-31, SAPO-37, and SAPO-41 are described in U.S. Pat. No. 4,440,871. SM-3 is described in U.S. Pat. Nos. 4,943,424; 5,087,347; 5,158,665; and 5,208,005. MgAPSO is a MeAPSO, which is an acronym for a metal aluminumsilicophosphate molecular sieve, where the metal, Me, is magnesium (Mg). Suitable MgAPSO-31 catalysts include MgAPSO-31. MeAPSOs are described in U.S. Pat. No. 4,793,984, and MgAPSOs are described in U.S. Pat. No. 4,758,419. MgAPSO-31 is a preferred MgAPSO, where 31 means a MgAPSO having structure type 31. Many natural zeolites, such as ferrierite, that have an initially reduced pore size can be converted to forms suitable for olefin skeletal isomerization by removing associated alkali metal or alkaline earth metal by ammonium ion exchange and calcination to produce the substantially hydrogen form, as taught in U.S. Pat. Nos. 4,795,623 and 4,924,027. Further catalysts and conditions for skeletal isomerization are disclosed in U.S. Pat. Nos. 5,510,306, 5,082,956, and 5,741,759. The hydroisomerization catalyst may also comprise a modifier selected from the group consisting of lanthanum, cerium, prascodymium, neodymium, samarium, gadolinium, terbium, and mixtures thereof, as described in U.S. Pat. Nos. 5,716,897 and 5,851,949. Other suitable support materials include ZSM-22, ZSM-23, and ZSM-35, which are described for use in dewaxing in U.S. Pat. No. 5,246,566 and in the article entitled S. J. Miller, “New Molecular Sieve Process for Lube Dewaxing by Wax Isomerization,” 2 Microporous Materials 439-449 (1994). U.S. Pat. Nos. 5,444,032 and 5,608,968 teach a suitable bifunctional catalyst which is constituted by an amorphous silica-alumina gel and one or more metals belonging to Group VIIIA and is effective in the hydroisomerization of long-chain normal paraffins containing more than 15 carbon atoms. U.S. Pat. Nos. 5,981,419 and 5,908,134 teach a suitable bifunctional catalyst which comprises: (a) a porous crystalline material isostructural with beta-zeolite selected from boro-silicate (BOR-B) and boro-alumino-silicate (Al-BOR-B) in which the molar SiO₂:Al₂O₃ ratio is higher than 300:1; (b) one or more metal(s) belonging to Group VIIIA, selected from platinum and palladium, in an amount comprised within the range of from 0.05 to 5% by weight. V. Calemma et al., App. Catal. A: Gen., 190 (2000), 207 teaches yet another suitable catalyst. Alumina or silica may be added to the support material.

DI-200 available from UOP LLC in Des Plaines, Illinois may be a suitable hydroisomerization catalyst.

Hydroisomerization conditions generally include a temperature of about 150° C. (302° F.) to about 450° C. (842° F.) and a pressure of about 1724 kPa (abs) (250 psia) to about 13.8 MPa (abs) (2000 psia). In another embodiment, the hydroisomerization conditions include a temperature of about 300° C. (572° F.) to about 360° C. (680° F.) and a pressure of about 3102 kPa (abs) (450 psia) to about 6895 kPa (abs) (1000 psia).

A hydroisomerized stream in a hydroisomerized line 134 from the hydroisomerization reactor 130b is a branched-paraffin-rich stream. By the term “rich” it is meant that the effluent stream has a greater concentration of branched paraffins than the stream entering the hydroisomerization reactor 130b, and preferably comprises greater than 50 mass-% branched paraffins of the total paraffin content. It is envisioned that the hydroisomerized effluent may contain 80, 90 or 95 mass-% branched paraffins of the total paraffin content. Hydroisomerization conditions in the hydroisomerization reactor 130b are selected to avoid undesirable cracking, so the predominant product in the hydroisomerized stream in the hydroisomerized line 134 is a branched paraffin. By avoiding undesirable hydrocracking, the hydroisomerized stream in the hydroisomerized line 134 will have the same composition with regard to carbon numbers as the incoming feed to the hydroisomerization reactor 130b. For example, although the incoming feed to the hydroisomerization reactor 130b may have 8 wt % paraffins with four carbon atoms, the hydroisomerized stream will also have 8 wt % paraffins with four carbon atoms although the hydroisomerized stream will have a greater proportion of paraffins that are isobutanes than the hydroisomerization feed stream and the hydroisomerization feed stream will have a greater proportion of paraffins that are normal butanes than the hydroisomerized stream. This principle will apply typically to paraffins of all carbon numbers passing through the hydroisomerization reactor 130b, but particularly applicable to paraffins with carbon numbers of three to seventeen. The optimal amount of remaining normal paraffins in line 134 is dependent on the selectivity of the hydroisomerization catalysts but might typically be between about 1 to about 7 wt-%.

In an exemplary embodiment, the hydrocracking reactor 130a and the hydroisomerization reactor 130b are stacked or located in single vessel 130. In a stacked configuration of the present disclosure, the hydrocracking reactor 130a is placed at a location above the hydroisomerization reactor 130b. For a stacked configuration, the combined hydroprocessing feed stream in line 132 comprising the first recycle diesel stream 182 is passed to the hydrocracking reactor 130a. The hydrocracked stream is withdrawn from the bottoms of the hydrocracking reactor 130a and passed to the hydroisomerization reactor 130b. The second recycle diesel stream 184 is also passed to the hydroisomerization reactor 130b. The second recycle diesel stream 184 bypasses the hydrocracking reactor 130a. The hydroisomerized stream in the hydroisomerized line 134 is withdrawn from the bottoms of the hydroisomerization reactor 130b.

The hydroisomerized stream in the hydroisomerized line 134 from the hydroisomerization reactor 130b flows to a hydroisomerization stripper column 140. In an aspect, the hydroisomerized stream in line 134 is separated in the hydroisomerization stripper column 140 to provide a hydroisomerized vapor stream in line 142 and a hydroisomerized liquid stream 144. A suitable stripping media in line 143 is also passed to the hydroisomerization stripper column 140. A stripping media which is an inert gas such as steam from a stripping media line 143 may be used to strip light gases from the hydroisomerized stream in line 134. The hydroisomerized vapor stream in line 142 comprising the light gases is taken from the overhead of the hydroisomerization stripper column 140.

The hydroisomerized liquid stream 144 is taken from the bottoms of the hydroisomerization stripper column 140 and passed to a product distillation column 150 for producing product streams without condensing and cooling.

The product distillation column 150 may be reboiled by heat exchange with a suitable hot stream or in a fired heater to provide the necessary heat for the distillation. Alternately, a stripping media which is an inert gas such as steam may be used to heat the column.

The product distillation column 150 provides an overhead gaseous stream of naphtha and steam in an overhead line 152 and a distillation bottoms liquid stream in a distillation bottoms line 156. The distillation overhead stream may be fully condensed and separated from water in a distillation receiver.

A product stream may be taken from a side of the product distillation column 150. A side stream comprising a jet fuel stream in line 154 may be taken from a side of the product distillation column 150. The jet fuel stream in line 154 may have a T5 of about 115° C. (239° F.) to about 130° C. (266° F.) and a T90 of about 240° C. (464° F.) to about 270° C. (518° F.). The jet fuel stream in line 154 will meet the ASTM D7566 jet fuel specification.

Returning to the product distillation column 150, the distillation bottoms liquid stream in the distillation bottoms line 156 may be a diesel stream having a T5 of about 270° C. (518° F.) to about 320° C. (608° F.) and a T90 of about 330° C. (626° F.) to about 399° C. (750° F.) The product distillation column 150 may be operated with a bottoms temperature between about 149° C. (300° F.) and about 288° C. (550° F.), preferably no more than about 260° C. (500° F.), and an overhead pressure of about 0.35 MPa (gauge) (50 psig), preferably no less than about 0.70 MPa (gauge) (100 psig), to no more than about 2.0 MPa (gauge) (290 psig).

The distillation bottoms liquid stream in the distillation bottoms line 156 has substantial concentration of the normal paraffins. The distillation bottoms liquid stream may be further hydroprocessed to further manage normal paraffin concentration. The distillation bottoms liquid stream in line 156 may be recycled to the hydroprocessing reactor 130.

The distillation bottoms liquid stream 156 may be separated into a product diesel stream in line 172 and a recycle diesel stream in line 174. The recycle diesel stream in line 174 is passed to the hydroprocessing reactor 130. In accordance with the present disclosure, the recycle diesel stream in line 174 is separated into the first recycle diesel stream and the second recycle diesel stream. In an aspect, a make-up hydrogen recycle stream in line 175 may be combined or mixed with the recycle diesel stream in line 174 before separating it into the first recycle diesel stream and the second recycle diesel stream. The recycle diesel stream in line 174 is mixed with the make-up hydrogen recycle stream in line 175 to provide a mixed diesel stream in line 176. The mixed diesel stream in line 176 is separated into a first recycle diesel stream in line 177 and a second recycle diesel stream in line 178.

In accordance with the present disclosure, the flow rate of the first recycle diesel stream in line 177 and the second recycle diesel stream in line 178 to the hydrocracking reactor 130a and the hydroisomerization reactor 130b is controlled and set to produce the jet fuel stream in line 154 meeting the jet fuel specification, preferably the ASTM D7566 jet fuel specification. In an aspect, a first proportion of the diesel stream fed into the first recycle diesel stream in line 177 to the hydrocracking reactor 130a and a second proportion of the diesel stream fed into the second recycle diesel stream in line 178 to the hydroisomerization reactor 130b is determined and also controlled based on a measured value of one or both of a density and a viscosity of the jet fuel stream in line 154. In accordance with the present disclosure, a flow rate of the first recycle diesel stream in line 177 and a flow rate of the second recycle diesel stream in line 178 are set based on a measured value of one or both of the density and the viscosity of said jet fuel stream in line 154.

In an exemplary embodiment, the jet fuel stream in line 154 is passed through a measuring device 160. In an embodiment, the measuring device 160 is a Coriolis mass flow meter. The Coriolis mass flow meter is connected or in communication with an online density meter 165. In an embodiment, the Coriolis mass flow meter is also connected or in communication with an online viscosity meter 163. The online density meter 165 compares a measured value of the density of the jet fuel stream in line 154 with a set point value for the desired density of the jet fuel. Similarly, the online viscosity meter 163 compares a measured value of the viscosity of the jet fuel stream in line 154 with a set point value for the desired viscosity of the jet fuel. Based on the comparison, the flow rate of the first recycle diesel stream in line 177 and the second recycle diesel stream in line 178 is determined and controlled as hereinafter described.

To adjust or control the flow rate, the first recycle diesel stream in line 177 is passed via a first ratio controller 181 before it is recycled to the hydrocracking reactor 130a. Similarly, the second recycle diesel stream in line 178 is passed to a second ratio controller 183 before it is recycled to the hydroisomerization reactor 130b. The first ratio controller 181 and the second ratio controller 183 are connected in communication with the online density meter 165 and the online viscosity meter 163. Based on a compared value of the density or the viscosity or both of the jet fuel stream, a controlled flow rate of the first recycle diesel stream in line 182 through first ratio controller 181 is passed to the hydrocracking reactor 130a and a controlled flow rate of the second recycle diesel stream in line 184 through the second ratio controller 183 is passed to the hydroisomerization reactor 130b.

If the measured value of the density of the jet fuel stream in line 154 does not match the set point value for the desired density of the jet fuel, a desired flow rate of the first recycle diesel stream in line 182 through the first ratio controller 181 is determined and adjusted so the density of the jet fuel stream in line 154 will be brought into line with the desired density of the jet fuel. So, if the density of the jet fuel stream in line 154 measured by the density meter 165 is higher than the set point value for the desired density of the jet fuel, the presence of heavier components in the jet fuel stream in line 154 is too high. Therefore, the flow rate of the first recycle diesel stream in line 182 through the first ratio controller 181 may be increased such that a higher proportion of the recycle diesel is passed through the hydrocracking reactor 130a to reduce the presence of heavier components in the jet fuel stream in line 154 by reduced hydrocracking. Proportionately, a flow rate of the second recycle diesel stream in line 184 through the second ratio controller 183 passed to the hydroisomerization reactor 130b is decreased.

On the other hand, if the value of the density of the jet fuel stream in line 154 measured by the density meter 165 is lower than the set point value for the desired density of the jet fuel, the presence of lighter components in the jet fuel stream in line 154 is too high. Therefore, the flow rate of the first recycle diesel stream in line 182 through the first ratio controller 181 may be decreased such that a lower proportion of the recycle diesel is passed to the hydrocracking reactor 130a to reduce the presence of lighter components in the jet fuel stream in line 154 by increased hydrocracking. Proportionately, a flow rate of the second recycle diesel stream in line 184 through the second ratio controller 183 passed to the hydroisomerization reactor 130b while bypassing the hydrocracking reactor 130a is increased.

Similarly, if the measured value of the viscosity of the jet fuel stream in line 154 does not match the set point value for the desired viscosity of the jet fuel, a desired flow rate of the first recycle diesel stream in line 182 through the first ratio controller 181 is determined and adjusted so the viscosity of the jet fuel stream in line 154 will be brought into line with the desired viscosity of the jet fuel. So, if the viscosity of the jet fuel stream in line 154 measured by the online viscosity meter 163 is higher than the set point value for the desired viscosity of the jet fuel, the presence of heavier components in the jet fuel stream in line 154 is too high. Therefore, the flow rate of the first recycle diesel stream in line 182 through the first ratio controller 181 may be decreased such that a lower proportion of the recycle diesel is passed to the hydrocracking reactor 130a to reduce the presence of heavier components in the jet fuel stream in line 154 by reduced hydrocracking. Proportionately, a flow rate of the second recycle diesel stream in line 184 through the second ratio controller 183 passed to the hydroisomerization reactor 130b is increased.

However, if the value of the viscosity of the jet fuel stream in line 154 measured by the online viscosity meter 163 is lower than the set point value for the desired viscosity of the jet fuel, the presence of lighter components in the jet fuel stream in line 154 is too high. Therefore, the flow rate of the first recycle diesel stream in line 182 through the first ratio controller 181 may be increased such that a higher proportion of the recycle diesel is passed to the hydrocracking reactor 130a to reduce the presence of lighter components in the jet fuel stream in line 154 by an increased hydrocracking. Proportionately, a flow rate of the second recycle diesel stream in line 184 through the second ratio controller 183 passed to the hydroisomerization reactor 130b while bypassing the hydrocracking reactor 130a is reduced.

In an exemplary embodiment, the first recycle diesel stream in line 182 may comprise from about 10 wt % to about 90 wt % of the diesel stream in line 176. In another exemplary embodiment the second recycle diesel stream in line 184 may comprise from about 90 wt % to about 10 wt % of the diesel stream in line 176.

The space velocity of a system is typically expressed on an hourly basis as the standard volumetric flow rate of the feed divided by the volume of catalyst bed. A liquid hourly space velocity (LHSV) is usually defined as standard volumetric flow rate of the liquid feed divided by the volume of catalyst bed and expressed on an hourly basis. In an aspect, the volume of the hydrocracking catalyst in the hydrocracking catalyst reactor 130a or the hydrocracking catalyst bed 135a is lower or equal to the volume of the hydroisomerization catalyst in the hydroisomerization reactor 130b or the hydroisomerization catalyst bed 135b. In accordance with an exemplary embodiment, the LHSV of the hydrocracking reactor 130a is higher or equal to the LHSV of the hydroisomerization reactor 130b without factoring in the flow rates of the recycle diesel streams in lines 182 and 184. In accordance with the present disclosure, the LHSV may be based on a flow rate of the hydrotreated liquid stream in line 126. The hydrotreated liquid stream in line 126 along with the first recycle diesel stream in line 182 is passed to the hydrocracking reactor 130a. In an aspect, by controlling the flow rate of recycle diesel to each of the hydrocracking reactor 130a and the hydroisomerization reactor 130b, the LHSV in each reactor can be controlled.

The dual injection configuration with variable LHSV of the recycle diesel streams produces a jet fuel range material which meets the ASTM D7566 jet fuel specification and also maintains or improves the yield of the produced jet fuel range material. A jet fuel stream meeting the ASTM D7566 jet fuel specification in line 162 may be withdrawn from the distillation column 150 in line 154 as shown in the FIG. 1.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring components, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### EXAMPLES

A simulation study with three different feeds, a normal feed, a heavy feed, and a light feed was conducted. Three different feeds were taken for the simulation study to demonstrate the benefits of splitting the recycle diesel stream into a first recycle diesel stream and a second recycle diesel stream with desired split proportion.

### Example 1

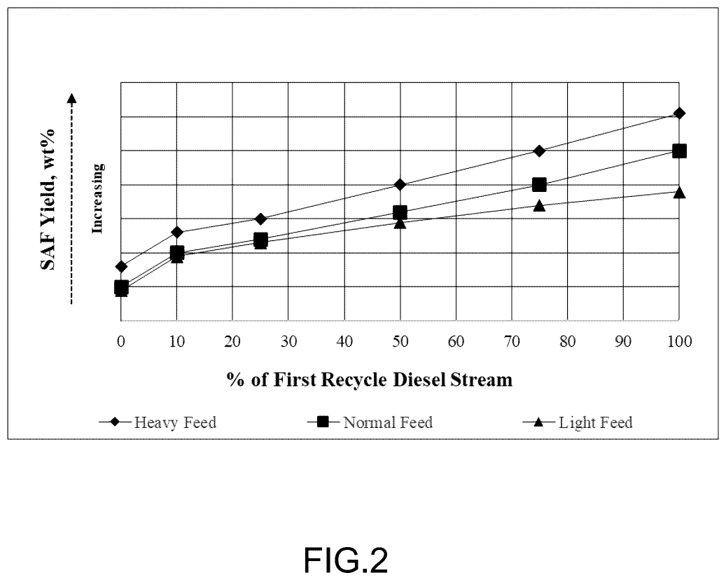

In Example 1, the jet fuel or sustainable aviation fuel (SAF) yield was compared with the percentage of first recycle diesel stream recycled to the hydrocracking catalyst for the normal feed, the heavy feed, and the light feed. The simulation study was performed with constant reactor temperature, pressure and SAF cut point for all three feeds. The Percentage of First Recycle Diesel Stream represents portion of recycle diesel stream recycled to the hydrocracking catalyst. The SAF yield versus the Percentage of First Recycle Diesel Stream is plotted and shown in FIG. 2. As evident from the FIG. 2, the SAF yield increased with increasing the percentage of first recycle diesel stream recycled to the hydrocracking catalyst for all three feeds, the normal feed, the heavy feed, and the light feed.

### Example 2

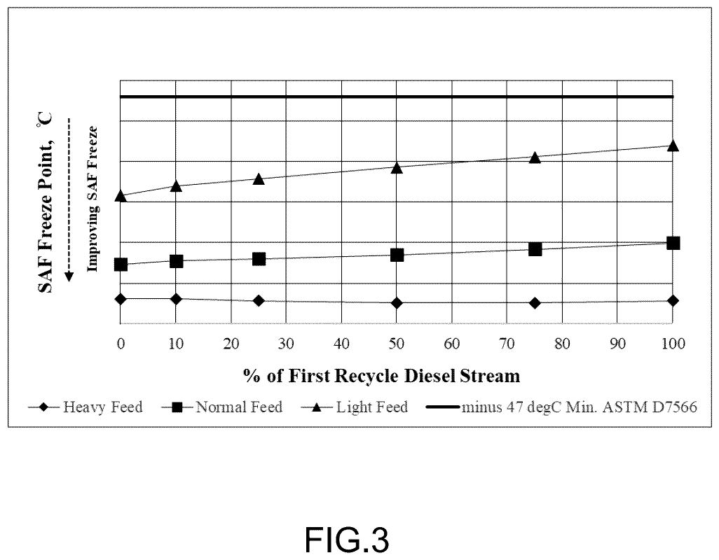

In Example 2, the SAF freeze point was compared with the percentage of first recycle diesel stream recycled to the hydrocracking catalyst for the three feeds. The simulation study was performed with constant reactor temperature, pressure and SAF cut point for all three feeds. The SAF Freeze Point versus the Percentage of First Recycle Diesel Stream recycled to the hydrocracking catalyst is plotted and shown in FIG. 3. As evident from the FIG. 3, the SAF freeze point was found to improve by increasing the percentage of first recycle diesel stream recycled to the hydrocracking catalyst for all three feeds, the normal feed, the heavy feed, and the light feed.

### Example 3

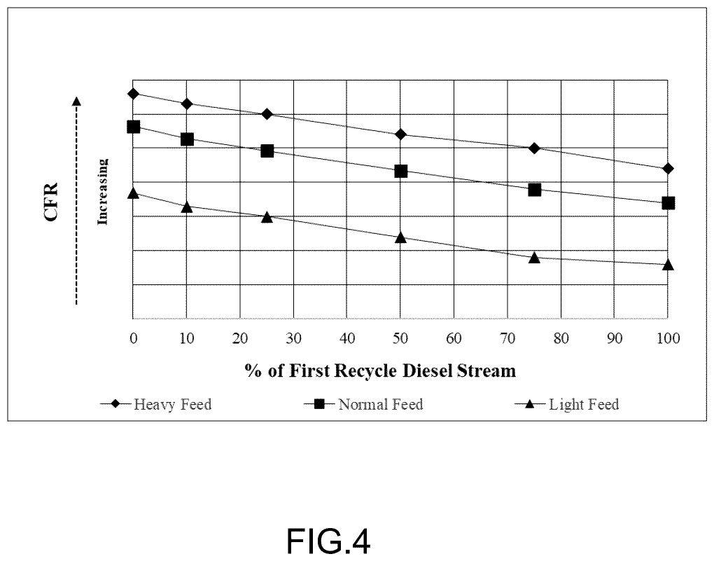

In Example 3, the SAF density was compared with the percentage of First Recycle Diesel Stream recycled to the hydrocracking catalyst for the three feeds. For this, a graph was plotted between combined feed ratio (CFR) and the Percentage Of First Recycle Diesel Stream recycled to the hydrocracking catalyst for the three feeds. The combined feed ratio was calculated by volumetric ratio of (feed rate+ recycle rate)/feed rate. The simulation study was performed with constant reactor temperature, pressure and SAF cut point for all three feeds. The CFR versus the Percentage of First Recycle Diesel Stream recycled to the hydrocracking catalyst is plotted and shown in FIG. 4. The SAF density was found to improve by increasing the percentage of first recycle diesel stream recycled to the hydrocracking catalyst for all three feeds, the normal feed, the heavy feed, and the light feed.

### SPECIFIC EMBODIMENTS

While the following is described in conjunction with specific embodiments, it will be understood that this description is intended to illustrate and not limit the scope of the preceding description and the appended claims.

A first embodiment of the present disclosure is a process for hydroprocessing a biorenewable feedstock, the process comprising hydrotreating the biorenewable feed stream in the presence of hydrogen over a hydrotreating catalyst in a hydrotreating reactor to hydrodeoxygenate the biorenewable feed stream to provide a hydrotreated stream; hydrocracking a hydrocracking feed stream taken from the hydrotreated stream in a hydrocracking reactor in the presence of hydrogen over a hydrocracking catalyst to provide a hydrocracked stream; hydroisomerizing a hydroisomerization feed stream taken from the hydrotreated stream in an hydroisomerization reactor in the presence of hydrogen over a hydroisomerization catalyst to provide a hydroisomerized stream; separating a jet fuel stream and a diesel stream from the hydroisomerized stream; separating the diesel stream into a first recycle diesel stream and a second recycle diesel stream; passing the first recycle diesel stream to the hydrocracking reactor; and passing the second recycle diesel stream to the hydroisomerization reactor. An embodiment of the present disclosure is one, any or all of prior embodiments in this paragraph up through the first embodiment in this paragraph wherein the second recycle diesel stream bypasses the hydrocracking reactor. An embodiment of the present disclosure is one, any or all of prior embodiments in this paragraph up through the first embodiment in this paragraph wherein the hydrocracking reactor and the hydroisomerization reactor are located in a single vessel. An embodiment of the present disclosure is one, any or all of prior embodiments in this paragraph up through the first embodiment in this paragraph further comprises passing the first recycle diesel stream to the hydrocracking reactor to provide the hydrocracked stream; and passing the hydrocracked stream and the second recycle diesel to the hydroisomerization reactor to provide the hydroisomerized stream. An embodiment of the present disclosure is one, any or all of prior embodiments in this paragraph up through the first embodiment in this paragraph further comprises measuring one or both of a density and a viscosity of the jet fuel stream; and setting the flow rate of the first recycle diesel stream and the flow rate of the second recycle diesel stream based on a measured value of one or both of the density and the viscosity of the jet fuel stream. An embodiment of the present disclosure is one, any or all of prior embodiments in this paragraph up through the first embodiment in this paragraph wherein the hydrocracking reactor is at a location above the hydroisomerization reactor in the vessel. An embodiment of the present disclosure is one, any or all of prior embodiments in this paragraph up through the first embodiment in this paragraph further comprises mixing the diesel stream with a make-up hydrogen stream to provide a mixed diesel stream; and separating the mixed diesel stream to provide the first recycle diesel stream and the second recycle diesel stream. An embodiment of the present disclosure is one, any or all of prior embodiments in this paragraph up through the first embodiment in this paragraph further comprises passing a hydrogen stream to a location between the hydrocracking reactor and the hydroisomerization reactor in the vessel. An embodiment of the present disclosure is one, any or all of prior embodiments in this paragraph up through the first embodiment in this paragraph further comprising controlling recycling of the diesel stream to the hydrocracking reactor and the hydroisomerization reactor by measuring one or both of a density and a viscosity of the jet fuel stream; comparing a measured value of one or both of the density and the viscosity of the jet fuel stream with a set point value of one or both of the density and the viscosity of the jet fuel stream to determine a first proportion of the diesel stream fed into the first recycle diesel stream and a second proportion of the diesel stream fed into the second recycle diesel stream; passing the first recycle diesel stream to a hydrocracking catalyst bed located in the hydrocracking reactor; and passing the second recycle diesel stream to an hydroisomerization catalyst bed located in the hydroisomerization reactor. An embodiment of the present disclosure is one, any or all of prior embodiments in this paragraph up through the first embodiment in this paragraph wherein the first recycle diesel stream comprises from 10 wt % about to about 90 wt % of the diesel stream and the second recycle diesel stream comprises from about 90 wt % to about 10 wt % of the diesel stream. An embodiment of the present disclosure is one, any or all of prior embodiments in this paragraph up through the first embodiment in this paragraph wherein the hydrocracking reactor is operating at a first liquid hourly space velocity and the hydroisomerization reactor is operating at a second liquid hourly space velocity, and wherein the first liquid hourly space velocity is higher or equal to the second liquid hourly space velocity.

A second embodiment of the present disclosure is a process for hydroprocessing a biorenewable feedstock, the process comprising hydrotreating the biorenewable feed stream in the presence of hydrogen over a hydrotreating catalyst in a hydrotreating reactor to hydrodeoxygenate the biorenewable feed stream to provide a hydrotreated stream; hydrocracking a hydrocracking feed stream taken from the hydrotreated stream in a hydrocracking reactor in the presence of hydrogen over a hydrocracking catalyst to provide a hydrocracked stream; hydroisomerizing a hydroisomerization feed stream taken from the hydrotreated stream in an hydroisomerization reactor in the presence of hydrogen over a hydroisomerization catalyst to provide a hydroisomerized stream; separating a jet fuel stream and a diesel stream from the hydroisomerized stream; measuring one or both of a density and a viscosity of the jet fuel stream; separating the diesel stream into the first recycle diesel stream and the second recycle diesel stream; setting the flow rate of the first recycle diesel stream and the flow rate of the second recycle diesel stream based on a measured value of one or both of the density and the viscosity of the jet fuel stream; passing the first recycle diesel stream to the hydrocracking reactor; and passing the second recycle diesel stream to the hydroisomerization reactor. An embodiment of the present disclosure is one, any or all of prior embodiments in this paragraph up through the second embodiment in this paragraph wherein the first recycle diesel stream comprises from about 10 wt % to about 90 wt % of the diesel stream and the second recycle diesel stream comprises from about 90 wt % to about 10 wt % of the diesel stream. An embodiment of the present disclosure is one, any or all of prior embodiments in this paragraph up through the second embodiment in this paragraph wherein the hydrocracking reactor and the hydroisomerization reactor are located in a single vessel. An embodiment of the present disclosure is one, any or all of prior embodiments in this paragraph up through the second embodiment in this paragraph wherein the hydrocracking reactor is placed at a location above the hydroisomerization reactor in the vessel. An embodiment of the present disclosure is one, any or all of prior embodiments in this paragraph up through the second embodiment in this paragraph wherein the second recycle diesel stream bypasses the hydrocracking reactor. An embodiment of the present disclosure is one, any or all of prior embodiments in this paragraph up through the second embodiment in this paragraph further comprises passing the first recycle diesel stream to the hydrocracking reactor to provide the hydrocracked stream; and passing the hydrocracked stream and the second recycle diesel to the hydroisomerization reactor to provide the hydroisomerized stream. An embodiment of the present disclosure is one, any or all of prior embodiments in this paragraph up through the second embodiment in this paragraph wherein the hydrocracking reactor is operating at a first liquid hourly space velocity and the hydroisomerization reactor is operating at a second liquid hourly space velocity, and wherein the first liquid hourly space velocity is higher or equal to the second liquid hourly space velocity. An embodiment of the present disclosure is one, any or all of prior embodiments in this paragraph up through the second embodiment in this paragraph further comprises mixing the diesel stream with a make-up hydrogen stream to provide a mixed diesel stream; and separating the mixed diesel stream to provide the first recycle diesel stream and the second recycle diesel stream. An embodiment of the present disclosure is one, any or all of prior embodiments in this paragraph up through the second embodiment in this paragraph wherein the step of setting the flow rate comprises comparing the measured value of one or both of the density and the viscosity of the jet fuel stream with a set point value of one or both of the density and the viscosity of the diesel stream to determine a first proportion of the diesel stream fed into the first recycle diesel stream and a second proportion of the diesel stream fed into the second recycle diesel stream.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for hydroprocessing a biorenewable feedstock, the process comprising:
hydrotreating said biorenewable feed stream in the presence of hydrogen over a hydrotreating catalyst in a hydrotreating reactor to hydrodeoxygenate said biorenewable feed stream to provide a hydrotreated stream;
hydrocracking a hydrocracking feed stream taken from said hydrotreated stream in a hydrocracking reactor in the presence of hydrogen over a hydrocracking catalyst to provide a hydrocracked stream;
hydroisomerizing a hydroisomerization feed stream taken from said hydrotreated stream in an hydroisomerization reactor in the presence of hydrogen over a hydroisomerization catalyst to provide a hydroisomerized stream;
separating a jet fuel stream and a diesel stream from said hydroisomerized stream;
separating said diesel stream into a first recycle diesel stream and a second recycle diesel stream;
passing said first recycle diesel stream to the hydrocracking reactor; and
passing said second recycle diesel stream to the hydroisomerization reactor.

2. The process of claim 1 wherein said second recycle diesel stream bypasses the hydrocracking reactor.

3. The process of claim 1 wherein the hydrocracking reactor and the hydroisomerization reactor are located in a single vessel.

4. The process of claim 3 further comprises:
passing said first recycle diesel stream to the hydrocracking reactor to provide said hydrocracked stream; and
passing said hydrocracked stream and said second recycle diesel to the hydroisomerization reactor to provide said hydroisomerized stream.

5. The process of claim 1 further comprises:
measuring one or both of a density and a viscosity of said jet fuel stream; and
setting the flow rate of said first recycle diesel stream and the flow rate of said second recycle diesel stream based on a measured value of one or both of the density and the viscosity of said jet fuel stream.

6. The process of claim 3 wherein the hydrocracking reactor is at a location above the hydroisomerization reactor in the vessel.

7. The process of claim 1 further comprises:
mixing said diesel stream with a make-up hydrogen stream to provide a mixed diesel stream; and
separating said mixed diesel stream to provide said first recycle diesel stream and said second recycle diesel stream.

8. The process of claim 3 further comprises passing a hydrogen stream to a location between the hydrocracking reactor and the hydroisomerization reactor in the vessel.

9. The process of claim 5 further comprising controlling recycling of said diesel stream to the hydrocracking reactor and the hydroisomerization reactor by:
measuring one or both of a density and a viscosity of said jet fuel stream;
comparing a measured value of one or both of the density and the viscosity of said jet fuel stream with a set point value of one or both of the density and the viscosity of said jet fuel stream to determine a first proportion of the diesel stream fed into said first recycle diesel stream and a second proportion of the diesel stream fed into said second recycle diesel stream;
passing said first recycle diesel stream to a hydrocracking catalyst bed located in the hydrocracking reactor; and
passing said second recycle diesel stream to an hydroisomerization catalyst bed located in the hydroisomerization reactor.

10. The process of claim 1 wherein said first recycle diesel stream comprises from 10 wt % about to about 90 wt % of said diesel stream and said second recycle diesel stream comprises from about 90 wt % to about 10 wt % of said diesel stream.

11. The process of claim 4 wherein the hydrocracking reactor is operating at a first liquid hourly space velocity and the hydroisomerization reactor is operating at a second liquid hourly space velocity, and wherein the first liquid hourly space velocity is higher or equal to the second liquid hourly space velocity.

12. A process for hydroprocessing a biorenewable feedstock, the process comprising:
hydrotreating said biorenewable feed stream in the presence of hydrogen over a hydrotreating catalyst in a hydrotreating reactor to hydrodeoxygenate said biorenewable feed stream to provide a hydrotreated stream;
hydrocracking a hydrocracking feed stream taken from said hydrotreated stream in a hydrocracking reactor in the presence of hydrogen over a hydrocracking catalyst to provide a hydrocracked stream;
hydroisomerizing a hydroisomerization feed stream taken from said hydrotreated stream in an hydroisomerization reactor in the presence of hydrogen over a hydroisomerization catalyst to provide a hydroisomerized stream;
separating a jet fuel stream and a diesel stream from said hydroisomerized stream;
measuring one or both of a density and a viscosity of said jet fuel stream;
separating said diesel stream into said first recycle diesel stream and said second recycle diesel stream;
setting the flow rate of said first recycle diesel stream and the flow rate of said second recycle diesel stream based on a measured value of one or both of the density and the viscosity of said jet fuel stream;
passing said first recycle diesel stream to the hydrocracking reactor; and
passing said second recycle diesel stream to the hydroisomerization reactor.

13. The process of claim 12 wherein said first recycle diesel stream comprises from about 10 wt % to about 90 wt % of said diesel stream and said second recycle diesel stream comprises from about 90 wt % to about 10 wt % of said diesel stream.

14. The process of claim 12 wherein the hydrocracking reactor and the hydroisomerization reactor are located in a single vessel.

15. The process of claim 14 wherein the hydrocracking reactor is placed at a location above the hydroisomerization reactor in the vessel.

16. The process of claim 15 wherein said second recycle diesel stream bypasses the hydrocracking reactor.

17. The process of claim 15 further comprises:
passing said first recycle diesel stream to the hydrocracking reactor to provide said hydrocracked stream; and
passing said hydrocracked stream and said second recycle diesel to the hydroisomerization reactor to provide said hydroisomerized stream.

18. The process of claim 15 wherein the hydrocracking reactor is operating at a first liquid hourly space velocity and the hydroisomerization reactor is operating at a second liquid hourly space velocity, and wherein the first liquid hourly space velocity is higher or equal to the second liquid hourly space velocity.

19. The process of claim 12 further comprises:
mixing said diesel stream with a make-up hydrogen stream to provide a mixed diesel stream; and
separating said mixed diesel stream to provide said first recycle diesel stream and said second recycle diesel stream.

20. A process for hydroprocessing a biorenewable feedstock, the process comprising:
hydrotreating said biorenewable feed stream in the presence of hydrogen over a hydrotreating catalyst in a hydrotreating reactor to hydrodeoxygenate said biorenewable feed stream to provide a hydrotreated stream;
hydrocracking a hydrocracking feed stream taken from said hydrotreated stream in a hydrocracking reactor in the presence of hydrogen over a hydrocracking catalyst to provide a hydrocracked stream;
hydroisomerizing a hydroisomerization feed stream taken from said hydrotreated stream in an hydroisomerization reactor in the presence of hydrogen over a hydroisomerization catalyst to provide a hydroisomerized stream;
separating a jet fuel stream and a diesel stream from said hydroisomerized stream;
measuring one or both of a density and a viscosity of said jet fuel stream;
separating said diesel stream into said first recycle diesel stream and said second recycle diesel stream;
setting the flow rate of said first recycle diesel stream and the flow rate of said second recycle diesel stream comparing the measured value of one or both of the density and the viscosity of said jet fuel stream with a set point value of one or both of the density and the viscosity of said diesel stream to determine a first proportion of the diesel stream fed into said first recycle diesel stream and a second proportion of the diesel stream fed into said second recycle diesel stream;
passing said first recycle diesel stream to the hydrocracking reactor; and
passing said second recycle diesel stream to the hydroisomerization reactor.
